(19) United States
(12) Patent Application Publication
(10) Pub. No.: US 2024/0009752 A1
(43) Pub. Date: Jan. 11, 2024

(54) CONTROL DEVICE, ELECTRODE POLISHING METHOD, AND ELECTRODE POLISHING SYSTEM

(71) Applicant: Fanuc Corporation, Minamitsuru-gun, Yamanashi (JP)

(72) Inventor: Yasuhiro Amagata, Minamitsuru-gun, Yamanashi (JP)

(73) Assignee: Fanuc Corporation, Minamitsuru-gun, Yamanashi (JP)

(21) Appl. No.: 18/036,231

(22) PCT Filed: Nov. 17, 2021
(86) PCT No.: PCT/JP2021/042302

§ 371 Date: May 10, 2023

(30) Foreign Application Priority Data
Nov. 24, 2020 (JP) 2020-194499

(51) Int. Cl. B23K 11/30

(52) U.S. Cl. CPC B23K 11/3063

(57) ABSTRACT

A controller includes an operating command generation unit for controlling at least one of a first drive source for applying pressure to an electrode, a second drive source for driving a polishing tool for polishing the electrode, and a third drive source for changing the position and/or orientation of one in relation to the other of the electrode and the polishing tool, and changing an operating command for the first drive source or at least one of the third drive source and the second drive source to be peak-shaped and valley-shaped in the course of at least one cycle of operation of the polishing tool.

### CROSS REFERENCE TO RELATED APPLICATIONS

This is the U.S. National Phase application of PCT/JP2021/042302, filed Nov. 17, 2021, which claims priority to Japanese Patent Application No. 2020-194499, filed Nov. 24, 2020, the disclosures of these applications being incorporated herein by reference in their entireties for all purposes.

### FIELD OF THE INVENTION

The present invention relates to art for polishing an electrode for resistance welding, more particularly relates to a controller, electrode polishing method, and electrode polishing system extending a lifetime of an electrode.

### BACKGROUND OF THE INVENTION

In recent years, aluminum alloys have been increasingly used for the purpose of lightening the weight of the bodies of automobiles etc. Aluminum alloys are low in electrical resistance, so in resistance welding of aluminum alloys, a large current is required and the electrodes easily become high in temperature at the time of welding. On the other hand, aluminum alloys are covered with an oxide film on their surfaces, so the base material of the melted film etc. easily deposit on the high temperature electrodes. The electrodes with the base material deposited on them gradually become greater in surface resistance thereby lowering the quality of the weld. Therefore, in welding of aluminum where a large current is particularly required, there is the problem that the electrodes become shorter in lifetime than the case of steel sheet. To maintain the quality of the weld, the conventional practice has been to periodically polish the electrodes by an electrode polishing apparatus. However, in particular, with welding of aluminum, it was necessary to frequently polish the electrodes so as to enable stable welding.

As a method of extending electrode lifetime, the method of roughening the electrode surface is known (for example, see PTLs 1 to 3). PTL 1 describes forming a rough surface on an electrode tip and, on the other hand, artificially forming a highly weldable inorganic nonmetallic coating on the surface of the aluminum being worked so as to thereby extend the effective lifetime. Roughening of the surface of the electrode is realized by sandblasting. It is believed that the projecting parts of the roughened surface of the electrode break the insulation layer at the surface of the aluminum being worked and thereby increase points of contact between the electrode and the aluminum being worked.

PTL 2 describes an electrode terminating in a rounded cone shape with a crown and giving the crown some texture. The electrode surface is roughened by blasting by small steel grit or sand particles or polishing by coarse polishing paper. The roughened electrode surface passes through the oxide film or contaminants of the welded part to lower the electrical resistance of the contact interface of the electrode surface with the part and lower the interface temperature and thereby reduce the discharge of the melted material.

PTL 3 describes to form concentric rings of ridges or grooves from the center of an electrode surface to thereby extend the electrode lifetime. To cut concentric ridges or grooves in the electrode surface, the cutting edge of the cutter blade has a wavy shape. The cutter blade is made to rotate about a center axis of the electrode to thereby form concentric rings at the electrode surface.

PTL 4 describes a tip dresser device having an electric motor for driving a tool. In the process of work for cutting the tip one time, the electric motor repeats several times a cycle of forward rotation by an amount of rotation A (for example, 2 to 3 revolutions) in the rotational direction of cutting and reverse rotation by an amount of rotation B (for example, ¼ to ½ revolutions).

PTL 5 describes a resistance welding apparatus having a top electrode and a bottom electrode wherein the bottom electrode has eight grooves extending radially from the center.

### PATENT LITERATURE

[PTL 1] U.S. Pat. No. 4,972,047 A
[PTL 2] U.S. Pat. No. 6,861,609 B2
[PTL 3] U.S. Pat. No. 8,436,269 B2
[PTL 4] JP 2001-287046 A
[PTL 5] JP 2005-193298 A

### SUMMARY OF THE INVENTION

In the prior art for extending electrode lifetime, sandblasting, polishing paper, a dedicated cutter, etc. has been used to roughen the electrode surface, so additional members have been required and the steps of work and costs have been increased.

Therefore, considering the conventional problems, the present invention has as its object the provision of an art of electrode polishing enabling an electrode lifetime to be extended without requiring special devices or work.

One aspect of the present disclosure provides a controller for controlling at least one of a first drive source for applying pressure to an electrode, a second drive source for driving a polishing tool for polishing the electrode, and a third drive source for changing at least one of a position and orientation of one of the electrode and the polishing tool with respect to the other, wherein the controller has an operating command generation unit for changing an operating command of the first drive source or at least one of the third drive source and the second drive source to be peak-shaped and valley-shaped in the course of at least one cycle of operation of the polishing tool.

Another aspect of the present disclosure provides an electrode polishing method controlling at least one of a first drive source for applying pressure to an electrode, a second drive source for driving a polishing tool for polishing the electrode, and a third drive source for changing at least one of a position and orientation of one of the electrode and the polishing tool with respect to the other so as to polish the electrode, wherein the electrode polishing method comprises a step of making an operating command of the first drive source or at least one of the third drive source and the second drive source to be peak-shaped and valley-shaped in the course of at least one cycle of operation of the polishing tool.

Still another aspect of the present disclosure provides an electrode polishing system comprising: a resistance welding machine having a first drive source for applying pressure to an electrode; an electrode polishing apparatus having a second drive source for driving a polishing tool for polishing the electrode; a third drive source for changing at least one of a position and orientation of one of the electrode and the polishing tool with respect to the other; and a controller for controlling at least one of the first drive source, the second drive source, and the third drive source, wherein the controller changes an operating command of the first drive source or at least one of the third drive source and the second drive source to be peak-shaped and valley-shaped in the course of at least one cycle of operation of the polishing tool.

According to one aspect of the present device, it is possible to roughen an electrode surface just by changing an operating command of a first drive source or at least one of a third drive source and second drive source to be peak-shaped and valley-shaped in the course of at least one cycle of operation of a polishing tool. In turn, it is possible to extend an electrode lifetime without requiring special devices or work.

### BRIEF DESCRIPTION OF DRAWINGS

FIG. 1 is a schematic view of the configuration of an electrode polishing system of one embodiment.

FIG. 2 is a side view showing one example of a polishing tool.

FIG. 3 is a plan view showing one example of a polishing tool.

FIG. 4 is a block diagram of control of an electrode polishing system of one embodiment.

FIG. 5A is a graph showing one example of a press force on an electrode.

FIG. 5B is a graph showing one example of a speed of a polishing tool.

FIG. 6A is a side view showing one example of an electrode polished by an electrode polishing method of an embodiment.

FIG. 6B is a plan view showing one example of an electrode polished by an electrode polishing method of an embodiment.

FIG. 7A is a graph showing a modification of a press force on an electrode.

FIG. 7B is a graph showing a modification of a speed of a polishing tool.

FIG. 8A is a graph showing another modification of a press force on an electrode.

FIG. 8B is a graph showing another modification of a speed of a polishing tool.

FIG. 9 is a schematic flowchart showing an electrode polishing method of an embodiment.

FIG. 10A is a graph showing another modification of a press force on an electrode.

FIG. 10B is a graph showing another modification of a speed of a polishing tool.

FIG. 11A is a graph showing still another modification of a press force on an electrode.

FIG. 11B is a graph showing still another modification of a speed of a polishing tool.

FIG. 12A is a side view of a polishing tool showing an electrode polishing method of another embodiment.

FIG. 12B is a side view of a polishing tool showing an electrode polishing method of another embodiment.

FIG. 13A is a side view showing one example of an electrode polished by an electrode polishing method of another embodiment.

FIG. 13B is a plan view showing one example of an electrode polished by an electrode polishing method of another embodiment.

FIG. 14 is a schematic flowchart showing an electrode polishing method of another embodiment.

FIG. 15A is a graph showing one example of a press force on a conventional electrode.

FIG. 15B is a graph showing one example of a speed of a conventional polishing tool.

FIG. 16A is a graph showing one example of a press force on a conventional electrode.

FIG. 16B is a graph showing one example of a speed of a conventional polishing tool.

FIG. 17A is a side view showing one example of an electrode polished by a conventional electrode polishing method.

FIG. 17B is a plan view showing one example of an electrode polished by a conventional electrode polishing method.

### DETAILED DESCRIPTION OF EMBODIMENTS OF THE INVENTION

Below, embodiments of the present disclosure will be explained in detail while referring to the attached drawings. In the drawings, the same or similar structural elements are assigned the same or similar notations. Further, the embodiments described below do not limit the technical scope of the invention and the significance of the terms described in the claims.

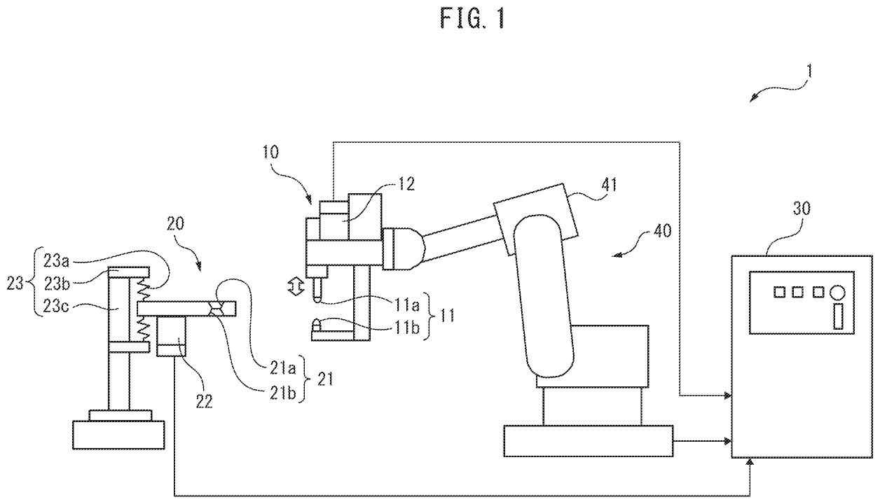

First, the configuration of an electrode polishing system 1 in the present embodiment will be explained. FIG. 1 is a schematic view of the configuration of the electrode polishing system 1. The electrode polishing system 1 is a system for polishing an electrode 11 of a resistance welding machine 10. The electrode polishing system 1 includes a resistance welding machine 10 having a first drive source 12 for applying pressure to an electrode 11, an electrode polishing apparatus 20 having a second drive source 22 for driving a polishing tool 21 for polishing the electrode 11, and a controller 30 for controlling at least one of the first drive source 12 and the second drive source 22. The resistance welding machine 10 is for example a C-shape spot welding gun. The resistance welding machine 10 has electrodes 11. The electrodes 11 for example comprise a pair of electrodes, that is, a first electrode 11a and a second electrode 11b. The first electrode 11a and the second electrode 11b face each other. For example, in a C-shape spot welding gun, the first electrode 11a is a movable electrode while the second electrode 11b is a fixed electrode facing the movable electrode.

The resistance welding machine 10 further has a first drive source 12 for applying pressure to the electrodes 11. The first drive source 12 drives at least one of the first electrode 11a and the second electrode 11b. The first drive source 12 has for example a servo motor. For example, in a C-shape spot welding gun, the first drive source 12 makes the first electrode 11a advance or retract in the arrow direction. That is, the first drive source 12 makes the first electrode 11a advance to press the first electrode 11a against the second electrode 11b while it makes the first electrode 11a retract to reduce the pressure of the first electrode 11a from the second electrode 11b. At the time of electrode polishing, the electrodes 11 are pressed against the polishing tool 21 to polish the electrodes 11.

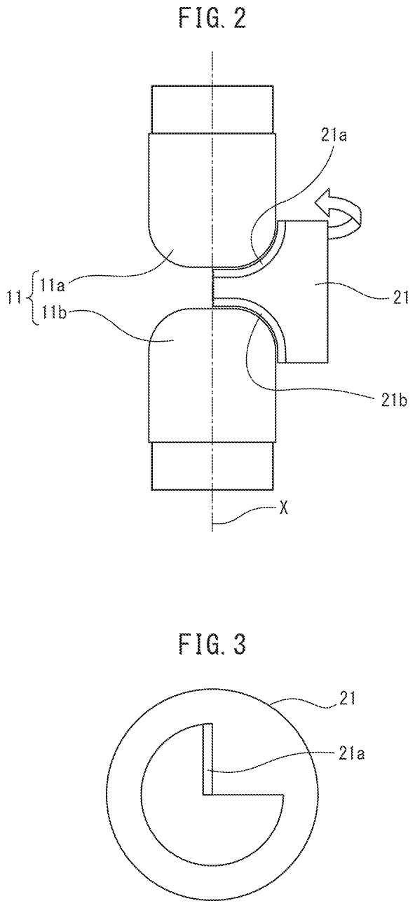

The electrode polishing apparatus 20 is, for example, a polishing cutter. The electrode polishing apparatus 20 has a polishing tool 21. The polishing tool 21 is, for example, provided with a pair of blades, that is, a first blade 21a and a second blade 21b. The first blade 21a and the second blade 21b face opposite sides from each other. FIG. 2 and FIG. 3 are a side view and a plan view showing one example of the polishing tool 21. The polishing tool 21 is integrally provided with the first blade 21a and the second blade 21b. The first blade 21a faces the first electrode 11a to polish the first electrode 11a, while the second blade 21b faces the second electrode 11b to polish the second electrode 11b. The cutting edges of the first blade 21a and the second blade 21b, for example, need only have existing blade shapes tailored to the dome radius shapes, radius shapes, or other shapes of general electrodes 11.

Referring again to FIG. 1, the electrode polishing apparatus 20 further has a second drive source 22 for driving the polishing tool 21. For example, in a polishing cutter, the second drive source 22 drives at least one of the first blade 21a and the second blade 21b. The second drive source 22 has for example a servo motor. For example, in a polishing cutter, the second drive source 22 turns the polishing tool 21 about the rotational axis X shown in FIG. 2 whereby the polishing tool 21 polishes the electrodes 11.

The electrode polishing apparatus 20 is set at a fixed position by, for example, a fastening member 23. For example, in a C-shape spot welding gun, only the first electrode 11a is pressed by the polishing tool 21, so in order for the second electrode 11b to be uniformly polished by the polishing tool 21 as well in the same way as the first electrode 11a, the fastening member 23 may have a spring 23a making the electrode polishing apparatus 20 move in the up-down direction. For example, the spring 23a, for example, includes a pair of springs, that is, a first spring and a second spring. The first spring and the second spring are respectively fastened to the front surface and back surface of the electrode polishing apparatus 20. The fastening member 23 further has a foundation 23c and brackets 23b for fastening the electrode polishing apparatus 20 to the foundation 23c. For example, the brackets 23b, for example, include a pair of brackets, that is, a first bracket and a second bracket. The first bracket and the second bracket respectively fastened the first spring and the second spring to the foundation 23c. The foundation 23c is set at a predetermined location and supports the electrode polishing apparatus 20.

The resistance welding machine 10 is conveyed by, for example, being attached to a robot or other conveyance device 40. The conveyance device 40 is for example a vertical articulated robot. The conveyance device 40 has a third drive source 41 for driving the drive shaft of the conveyance device 40. For example, in the case of an articulated robot, a third drive source 41 is provided at each of the articulated shafts of the robot. The third drive source 41 is for example a servo motor. The third drive source 41 is controlled by, for example, the controller 30. The controller 30 controls the third drive source 41 to make the conveyance device 40 operate. For example, the controller 30 controls the third drive source 41 so as to position the front ends of the electrodes 11 of the resistance welding machine 10 at the polishing tool 21 of the electrode polishing apparatus 20. Due to this, the conveyance device 40 conveys the resistance welding machine 10 to the electrode polishing apparatus 20.

The controller 30 is, for example, a robot controller. The controller 30 controls at least one of the first drive source 12 and the second drive source 22 in addition to the third drive source 41 for driving the conveyance device 40. That is, the controller 30 controls the current, speed, position, etc. of at least one of the first drive source 12, the second drive source 22, and the third drive source 41. When these drive sources are, for example, rotary type motors, the controller 30 controls the torque (current), rotational speed, rotational position, etc. of the motors. When these drive sources are, for example, linear motors, the controller 30 controls the propulsion (current), linear velocity, linear position, etc. of the motors. Further, the controller 30 also communicates with another external device (not shown) such as a line control panel. The controller 30 has, for example, a programmable controller (PLC) containing a processor or a driver for driving the motors etc.

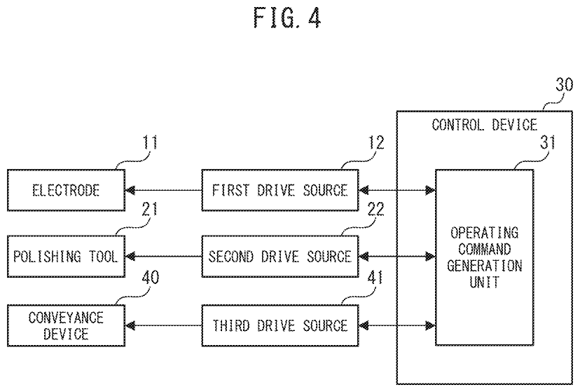

FIG. 4 is a block diagram of control of the electrode polishing system 1 of the present embodiment. The controller 30 has an operating command generation unit 31 for generating an operating command of at least one of the first drive source 12, the second drive source 22, and the third drive sources 41. Note that an “operating command” means one of the current, speed, position, etc. of these drive sources (same below). The operating command generation unit 31 has, for example, a processor capable of executing a program, such as a CPU (central processing unit), MPU (micro processing unit), etc. The operating command generation unit 31 makes the operating command of at least one of the first drive source 12 and the second drive source 22 change to be peak-shaped and valley-shaped in the course of at least one cycle of operation of the polishing tool 21.

The above configuration of the electrode polishing system 1 is one example. Note that other configurations can also be employed. For example, the resistance welding machine 10 may be not a C-shape spot welding gun, but an X-shape spot welding gun. In the case of an X-shape spot welding gun, the first electrode 11a and the second electrode 11b are respectively attached to a pair of gun arms configured to open/close by the first drive source 12. Further, the first drive source 12 may be not a servo motor but, for example, a press cylinder (air cylinder, hydraulic cylinder, etc.) with a solenoid valve. In this case, the controller 30 controls the operating command (current, speed, position, etc.) of the solenoid valve. Alternatively, the resistance welding machine 10 may be not a spot welding machine, but other resistance welding machine. For example, the resistance welding machine 10 may be another lap welding machine such as a projection welding machine or a seam welding machine, or may be another butt welding machine such as an upset welding or a flash welding machine.

Further, the polishing tool 21 of the electrode polishing apparatus 20 may be not a polishing cutter, but other rotary type polishing tool such as a polishing roller, or may be other linear polishing tool such as a polishing pad or polishing brush. Furthermore, the electrode polishing apparatus 20 may be not set at a fixed position, but be conveyed by, for example, a robot or other conveyance device 40 to the resistance welding machine 10. In addition, the second drive source 22 may be not a servo motor, but, for example, a press cylinder with a solenoid valve. In this case, the controller 30 controls the operating command (current, speed, position, etc.) of the solenoid valve.

Further, the resistance welding machine 10 may not be attached to the conveyance device 40, but be set at a fixed position. In this case, the hand is attached to the conveyance device 40, and at the time of welding a workpiece, the conveyance device 40 conveys the workpiece gripped by the hand to the resistance welding machine 10. On the other hand, at the time of electrode polishing, the conveyance device 40 may convey the electrode polishing apparatus 20 gripped by the hand to the resistance welding machine 10. Further, the conveyance device 40 may be not a vertical articulated robot, but may be other industrial robot such as a horizontal articulated robot or a parallel link type robot, or may be other type of robot such as a humanoid robot. Alternatively, the conveyance device may be not a robot, but may be other conveyance device such as an automated guided vehicle (AGV) or a shuttle.

Further, the controller 30 may also be not a robot controller, but a dedicated controller exclusively controlling at least one of the first drive source 12 of the resistance welding machine 10 and the second drive source 22 of the electrode polishing apparatus 20. In this case, the robot controller and the dedicated controller may be communicably connected to each other by wire or wireless, so that the devices send and receive information with each other, and synchronize the timings of welding and polishing. Furthermore, the operating command generation unit 31 of the controller 30 may be not a processor for running a program, but may be constituted by another semiconductor integrated circuit not running a program, such as an FPGA (field-programmable gate array) or an ASIC (application specific integrated circuit).

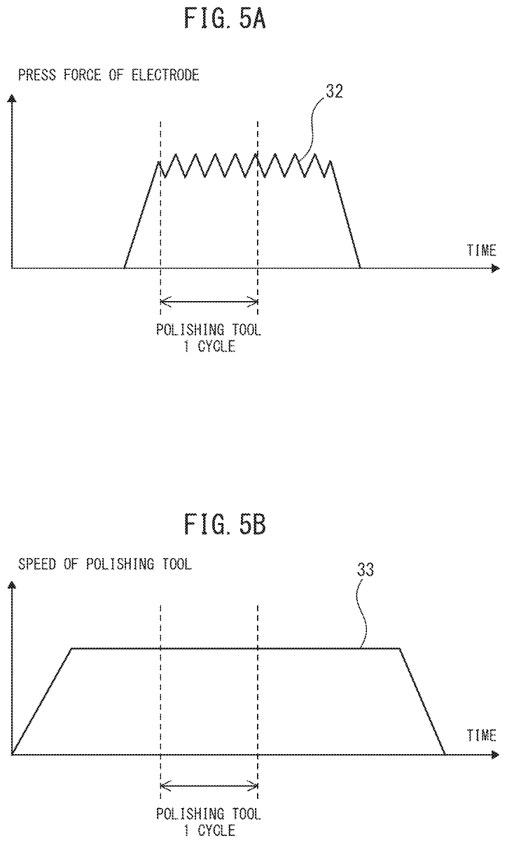

Below, change of an operating command generated at the operating command generation unit 31 will be explained. FIG. 5A and FIG. 5B respectively are graphs showing one example of a press force 32 on an electrode 11 and a speed 33 of the polishing tool 21. In this example, the operating command generation unit 31 makes the operating command of the first drive source 12 (current, speed, position, etc.) change to be peak-shaped and valley-shaped in the course of at least one cycle of operation of the polishing tool 21 so as to make the press force 32 on the electrode 11 change in small increments (see FIG. 5A). Note that, “one cycle” in a rotary type polishing tool 21 means one revolution and in a linear type polishing tool 21 means one reciprocating motion (same below). On the other hand, the operating command generation unit 31 maintains the operating command of the second drive source 22 (current, speed, etc.) constant so as to maintain the speed 33 of the polishing tool 21 constant (see FIG. 5B). That is, the controller 30 maintains the speed 33 of the polishing tool 21 constant while changing the operating command of the first drive source 12 in small increments so as to make the press force 32 on the electrode 11 change in small increments.

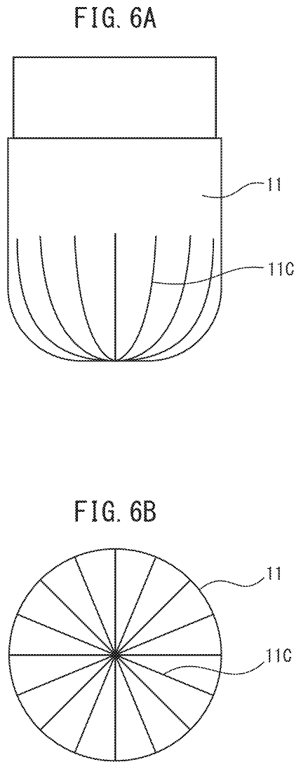

FIG. 6A and FIG. 6B are a side view and plan view showing one example of an electrode 11 polished by the electrode polishing method of the present embodiment. In this example, a conventional rotary type polishing cutter (see FIG. 2) is used as the polishing tool 21 and the controller 30 cyclically changes the operating command of the first drive source 12 to thereby make the press force 32 on the electrode 11 cyclically change and polish the electrode 11. The surface of the polished electrode 11 is formed with ridges or grooves 11c extending radially from the center of the electrodes 11 at equal intervals. Alternatively, even if using a conventional linear type polishing pad (not shown) as the polishing tool 21, the surface of the electrode 11 is formed with ridges or grooves extending traversing the surface of the electrode 11 in parallel at equal intervals. That is, by just making the operating command of the first drive source 12 change in small increments, the surface of the electrode 11 can be roughened. In turn, it is possible to extend the lifetime of the electrode 11 without requiring special devices or work.

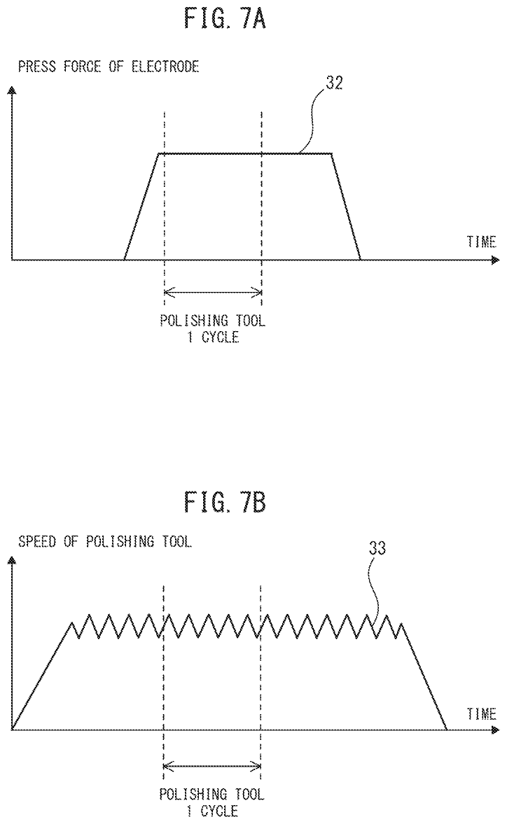

FIG. 7A and FIG. 7B are respectively graphs showing a modification of the press force 32 on an electrode 11 and the speed 33 of the polishing tool 21. In this example, the operating command generation unit 31 makes the speed command of the second drive source 22 change to be peak-shaped and valley-shaped in the course of at least one cycle of operation of the polishing tool 21 so as to make the speed 33 of the polishing tool 21 change in small increments (see FIG. 7B). On the other hand, the operating command generation unit 31 maintains the operating command of the first drive source 12 (current, speed, position, etc.) constant so as to maintain the press force 32 on the electrode 11 constant (see FIG. 7A). That is, the controller 30 maintains the press force 32 on the electrode 11 constant while making the speed command of the second drive source 22 change in small increments so as to make the speed 33 of the polishing tool 21 change in small increments. Alternatively, the controller 30 may maintain the press force 32 on the electrode 11 constant while making the current command (torque command) of the second drive source 22 change in small increments so as to make the polishing force (torque) of the polishing tool 21 change in small increments.

For example, if using a conventional rotary type polishing cutter (see FIG. 2) as the polishing tool 21, even if the press force 32 on an electrode 11 is constant, by making the speed 33 of the polishing tool 21 cyclically change, uneven cutting cyclically occurs. That is, the surface of the electrode 11 is formed with wide ridges or grooves 11c extending radially at equal intervals. Alternatively, for example, if using a conventional linear type polishing pad (not shown) as the polishing tool 21, even if the press force 32 on the electrode 11 is constant, by making the speed 33 of the polishing tool 21 cyclically change, uneven cutting cyclically occurs. That is, the surface of the electrode 11 is formed with wide ridges or grooves 11c extending in parallel at equal intervals. That is, by just making the operating command of the second drive source 22 change in small increments, the surface of the electrode 11 can be roughened. In turn, it is possible to extend the lifetime of the electrode 11 without requiring special devices or work.

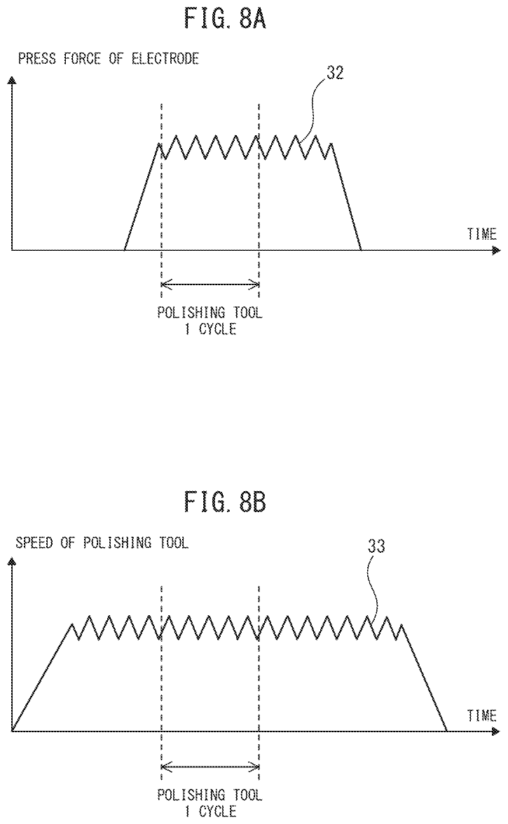

FIG. 8A and FIG. 8B are respectively graphs showing another modification of the press force 32 on ab electrode 11 and the speed 33 of the polishing tool 21. In this example, the operating command generation unit 31 makes the operating commands of both of the first drive source 12 and the second drive source 22 change to be peak-shaped and valley-shaped in the course of at least one cycle of operation of the polishing tool 21 so as to make both the press force 32 on the electrode 11 and the speed 33 of the polishing tool 21 change in small increments. That is, the controller 30 may make the operating commands of both of the first drive source 12 and the second drive source 22 change in small increments so as to make both the press force 32 on the electrode 11 and the speed 33 of the polishing tool 21 change in small increments.

Further, the controller 30 may also synchronize the operating commands of both the first drive source 12 and the second drive source 22 so as to synchronize the press force 32 on an electrode 11 and the speed 33 of the polishing tool 21. Due to this, rights or grooves of the intended shapes are cleanly formed at the surface of the electrode 11. For example, by synchronizing the peak parts of the operating command of the first drive source 12 (that is, the peak parts of the press force 32 on the electrode 11) and the valley parts of the operating command of the second drive source 22 (that is, the valley parts of the speed 33 of the polishing tool 21), higher ridges or deeper grooves are formed at the surface of the electrode 11. Further, for example, by synchronizing the peak parts of the operating command of the first drive source 12 (that is, the peak parts of the press force 32 on the electrode 11) and the peak parts of the operating command of the second drive source 22 (that is, the peak parts of the speed 33 of the polishing tool 21), wider ridges or wider grooves are formed at the surface of the electrode 11.

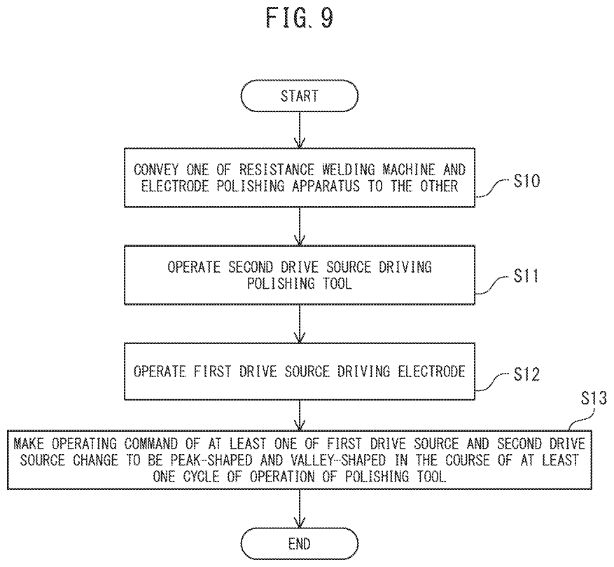

FIG. 9 is a schematic flowchart of the electrode polishing method of the present embodiment. This flowchart is realized by a program performed by the processor of the controller 30 or other semiconductor integrated circuit. First, at step S10, the conveyance device 40 conveys one of the resistance welding machine 10 and the electrode polishing apparatus 20 to the other. For example, a robot mounting the resistance welding machine 10 conveys the resistance welding machine 10 to the electrode polishing apparatus 20, or, a robot gripping the electrode polishing apparatus 20 conveys the electrode polishing apparatus 20 to the resistance welding machine 10.

At step S11, the controller 30 makes the second drive source 22 driving the polishing tool 21 operate. For example the second drive source 22 makes the polishing tool 21 engage in rotary motion or reciprocating motion. At step S12, the controller 30 makes the first drive source 12 driving an electrode 11 operate. For example, the first drive source 12 presses the electrode 11 against the polishing tool 21. Due to this, polishing of the electrode 11 is started.

At step S13, the controller 30 makes the operating command of at least one of the first drive source 12 and the second drive source 22 change to be peak-shaped and valley-shaped in the course of at least one cycle of operation of the polishing tool 21 so as to make at least one of the press force of the electrode 11 and the speed of the polishing tool 21 change in small increments. For example, the speed of the polishing tool 21 is maintained constant while the press force of the electrode 11 is made to cyclically change. In this way, by just making at least one of the press force of the electrode 11 and the speed of the polishing tool 21 change in small increments, the surface of the electrode 11 can be roughened. In turn, it is possible to extend the lifetime of the electrode 11 without requiring special devices or work.

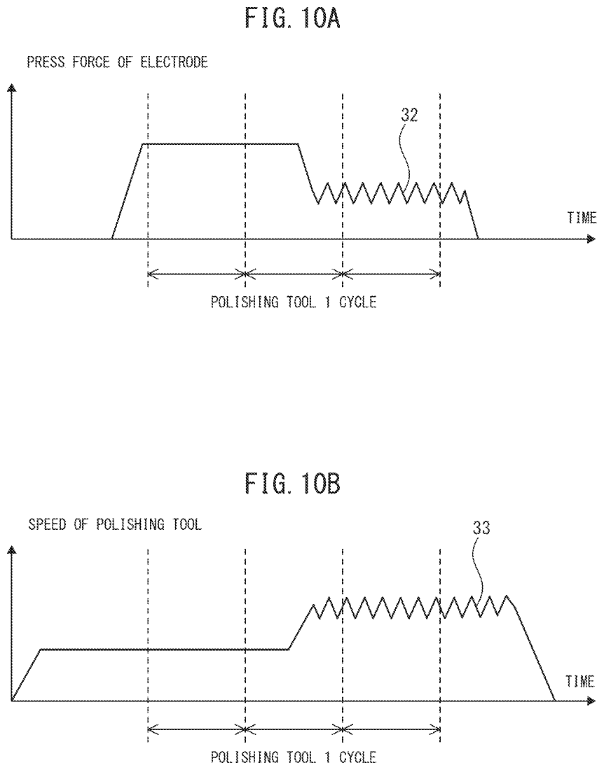

FIG. 10A and FIG. 10B are respectively graphs showing another modification of the press force 32 on an electrode 11 and the speed 33 of the polishing tool 21. In this example, rough cutting is first performed like in conventional electrode polishing, then finish cutting is performed while changing at least one of the press force 32 on the electrode 11 and the speed 33 of the polishing tool 21. That is, operating command generation unit 31 maintains the operating commands of both of the first drive source 12 and the second drive source 22 (current, speed, position, etc.) constant for a predetermined time period so as to perform rough cutting while maintaining the press force 32 on the electrode 11 and the speed 33 of the polishing tool 21 constant for a predetermined time period. After that, the operating command generation unit 31 makes the operating command of at least one of the first drive source 12 and the second drive source 22 (current, speed, position, etc.) change to be peak-shaped and valley-shaped in the course of at least one cycle of operation of the polishing tool 21 so as to perform finish cutting while making at least one of the press force 32 on the electrode 11 and the speed 33 of the polishing tool 21 change in small increments. By performing rough cutting, the base material deposited on the electrode 11 or the ridges or grooves formed by the previous polishing are removed. On the other hand, by performing finish cutting, the surface of the electrode 11 is formed with new ridges or grooves. Due to this, the surface of the electrode 11 is roughened cleanly and the lifetime of the electrode 11 can be extended more.

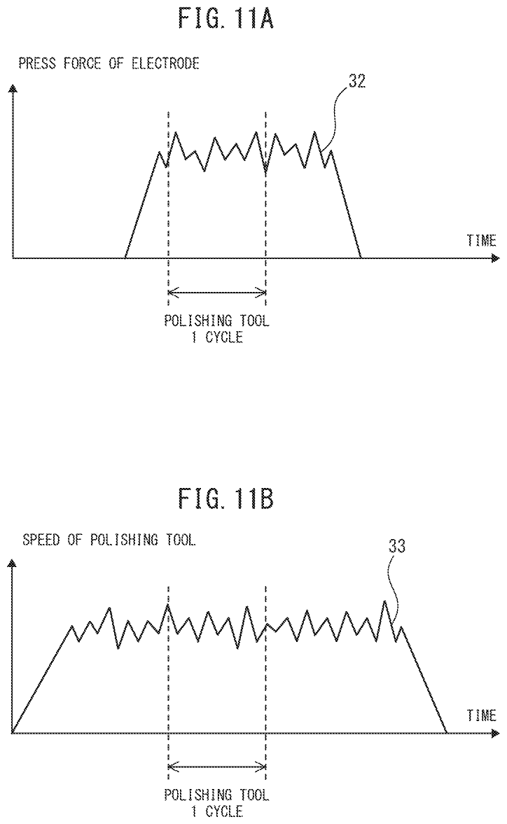

FIG. 11A and FIG. 11B are respectively graphs showing still another modification of the press force 32 on an electrode 11 and the speed 33 of the polishing tool 21. In this example, the operating command generation unit 31 makes the operating command of at least one of the first drive source 12 and the second drive source 22 (current, speed, position, etc.) randomly change in the course of at least one cycle of operation of the polishing tool 21 so as to make at least one of the press force 32 on the electrode 11 and the speed 33 of the polishing tool 21 randomly change. In this way, even if making at least one of the press force of the electrode 11 and the speed of the polishing tool 21 randomly change, the surface of the electrode 11 is formed with random ridges or grooves (not shown) and the surface of the electrode 11 can be roughened. Therefore, it is possible to roughen the surface of the electrode 11 to extend the lifetime of the electrode 11 without requiring special devices or work.

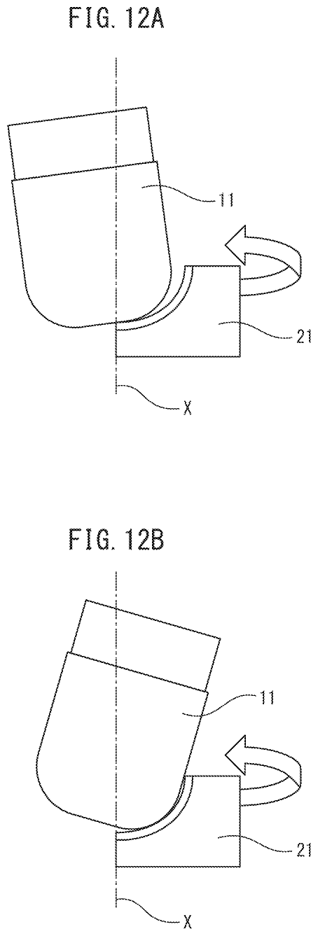

FIG. 12A and FIG. 12B are side views of a polishing tool showing an electrode polishing method of another embodiment. In this example, the operating command generation unit 31 makes the operating command of the third drive source 41 for driving a drive shaft of the conveyance device 40 conveying the resistance welding machine 10 further change so as to change at least one of the position and orientation of the electrode 11 with respect to the polishing tool 21 while polishing the electrode 11. That is, the controller 30 makes the operating command of the third drive source 41 change to be peak-shaped and valley-shaped in the course of at least one cycle of operation of the polishing tool 21 so as to make at least one of the position and orientation of the electrode 11 with respect to the polishing tool 21 change in small increments. Alternatively, the operating command generation unit 31 may make the operating command of the third drive source for driving a drive shaft of the conveyance device conveying the electrode polishing apparatus 20 change in small increments so as to make at least one of the position and orientation of the polishing tool 21 with respect to the electrode 11 change while polishing the electrode 11.

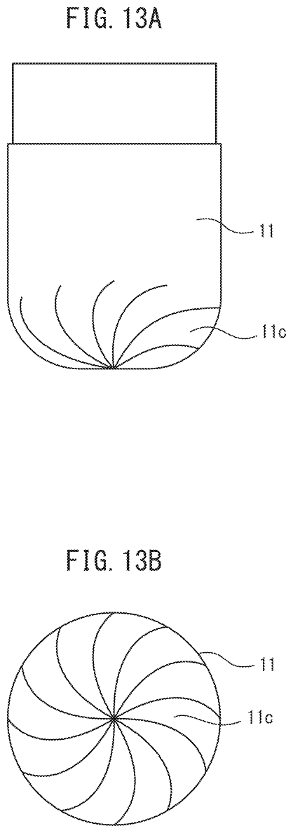

FIG. 13A and FIG. 13B are respectively a side view and plan view showing one example of an electrode 11 polished by the electrode polishing method of this embodiment. If using a conventional rotary type polishing cutter (see FIG. 2) for the polishing tool 2, by changing at least one of the position and orientation, for example, the angle, of one of the electrode 11 and the polishing tool 21 with respect to the other, in small increments, the surface of the polished electrode 11 is formed with ridges or grooves 11c extending curved radially from the center of the electrode 11. That is, the controller 30 can just make the operating command of the third drive source 41 for making the angle of one of the electrode 11 and the polishing tool 21 with respect to the other change in small increments to thereby roughen the surface of the electrode 11 while the polishing tool 21 operates for at least one cycle. Further, even if not providing the spring 23a for making the electrode polishing apparatus 20 move in the up-down direction such as shown in FIG. 2, by making the operating command of the third drive source 41 change, it becomes possible to uniformly polish the first electrode 11a (for example, the movable electrode) and the second electrode 11b.

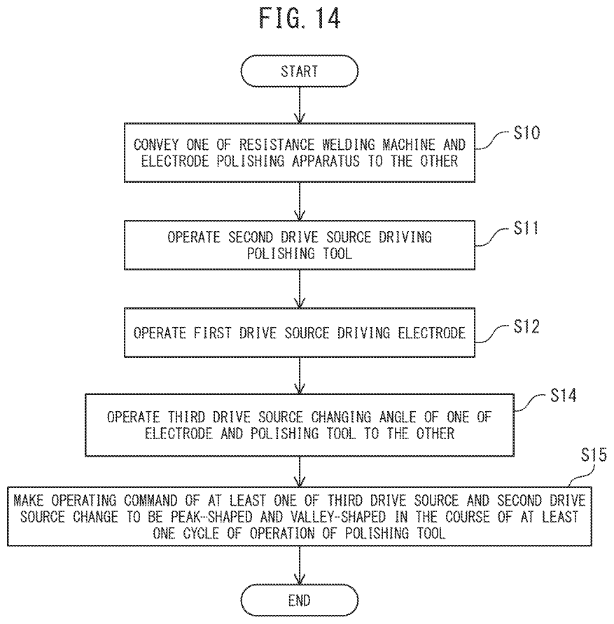

FIG. 14 is a schematic flowchart of the electrode polishing method of another embodiment. Note that step S10 to step S13 shown in FIG. 14 are the same as step S10 to step S13 shown in FIG. 9. For example, at step S11, the second drive source 22 makes the polishing tool 21 engage in rotary motion or reciprocating motion while at step S12, the controller 30 makes the first drive source 12 for applying pressure to an electrode 11 operate. For example, the first drive source 12 presses an electrode 11 against the polishing tool 21. Due to this, the electrode 11 starts to be polished. At step S14, the controller 30 makes the third drive source 41 for changing the angle of one of the electrode 11 and the polishing tool 21 with respect to the other operate. Further, at step S15, the controller 30 makes the operating command of at least one of the third drive source 41 and the second drive source 22 change to be peak-shaped and valley-shaped in the course of at least one cycle of operation of the polishing tool 21 so as to make the angle of one of the electrode 11 and the polishing tool 21 with respect to the other cyclically or randomly change. Due to this, for example, the surface of the electrode 11 can be formed with ridges or grooves 11c extending curved radially from the center of the electrode 11. In turn, it is possible to extend the lifetime of the electrode 11 without requiring special devices or work.

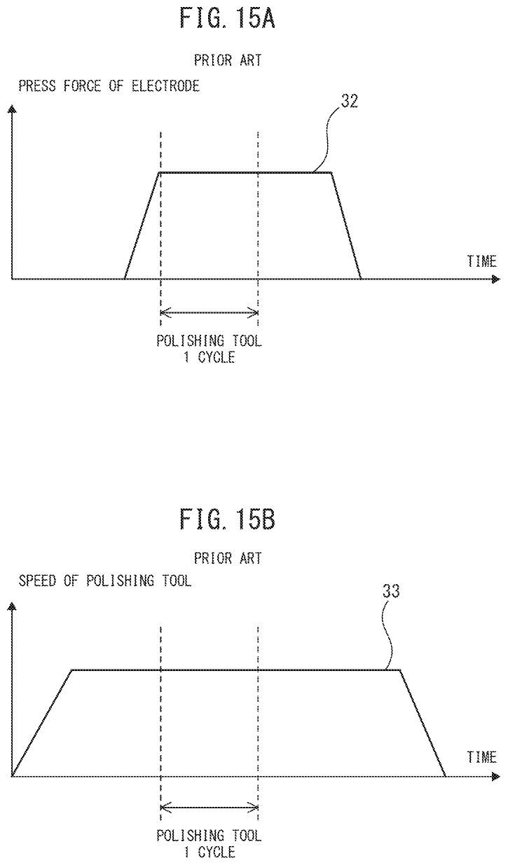

Below, as a comparative example against the above-mentioned embodiments, an example of the conventional electrode polishing method will be explained. FIG. 15A and FIG. 15B are respectively graphs showing one example of the press force 32 on a conventional electrode 11 and the speed 33 of a conventional polishing tool 21. The conventional operating command generation unit 31 maintains the operating commands of both the first drive source 12 and the second drive source 22 (current, speed, position, etc.) constant to thereby maintain the press force 32 on the electrode 11 and the speed 33 of the polishing tool 21 constant and polish the electrode 11. Due to this, the base material deposited on the electrode 11 can be removed, whereas the surface of the electrode 11 cannot be roughened.

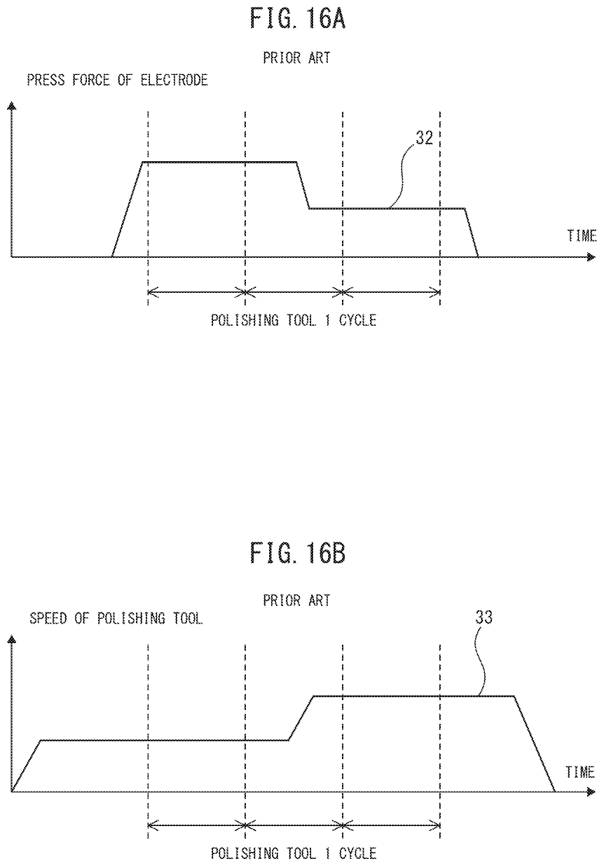

FIG. 16A and FIG. 16B similarly are respectively graphs showing one example of the press force 32 on a conventional electrode 11 and the speed 33 of a conventional polishing tool 21. In the prior art, the press force 32 on the electrode 11 is raised and the speed 33 of the polishing tool 21 is slowed to perform rough cutting, then the press force 32 on the electrode 11 is lowered and the speed 33 of the polishing tool 21 is raised to perform finish cutting. Rough cutting enables the base material deposited on the electrode 11 to be removed while finish cutting enabled the surface of the electrode 11 to be made smooth, whereas the surface of the electrode 11 cannot be roughened.

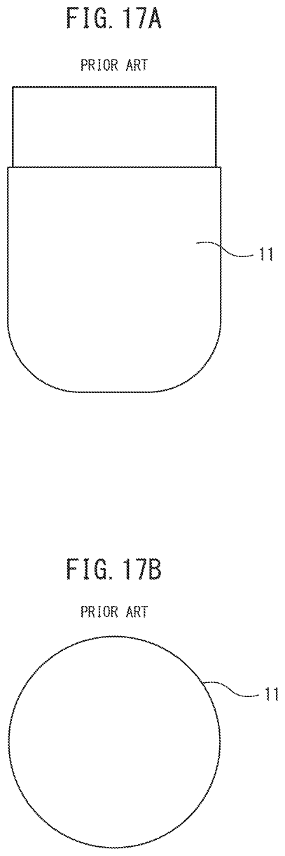

FIG. 17A and FIG. 17B are respectively a side view and plan view showing one example of an electrode 11 polished by a conventional electrode polishing method. The surface of the electrode 11 polished by the conventional electrode polishing method is cleared of the deposited base material and thereby made smooth, but is not roughened. Therefore, by again performing resistance welding, the base material deposits on the surface of the electrode 11 and the surface resistance gradually becomes greater ending up causing deterioration of the quality of the weld. However, according to the art of electrode polishing of the above-mentioned embodiments, the surface of the electrode 11 can be roughened by just changing the operating command of at least one of the first drive source 12 and the second drive source 22 in small increments. In turn, it is possible to extend the lifetime of the electrode 11 without requiring special devices or work.

The programs run by the above-mentioned processor or other semiconductor integrated circuits etc. or the programs performing the operations in the above-mentioned flowcharts may also be provided recorded on computer-readable nontransitory recording media such as a CD-ROM etc. Alternatively, they may be provided distributed wired or wirelessly from a server apparatus on a WAN (wide area network) or LAN (local area network).

In this Description, various embodiments were explained, but the present invention is not limited to the afore-mentioned embodiments. It should be understood that various modifications can be made within the scope defined in the claims.

### REFERENCE SIGNS LIST

1 electrode polishing system
10 resistance welding machine
11 electrode
11a first electrode
11b second electrode
11c ridge or groove
12 first drive source
20 electrode polishing apparatus
21 polishing tool
21a first blade
21b second blade
22 second drive source
23 fastening member
23a spring
23b bracket
23c foundation
30 controller
31 operating command generation unit
32 press force on electrode
33 speed of polishing tool
conveyance device
41 third drive source
X rotational axis

1. A controller for controlling at least one of a first drive source for applying pressure to an electrode, a second drive source for driving a polishing tool for polishing the electrode, and a third drive source for changing at least one of a position and orientation of one of the electrode and the polishing tool with respect to the other,
wherein the controller has an operating command generation unit for changing an operating command of the first drive source or at least one of the third drive source and the second drive source to be peak-shaped and valley-shaped in the course of at least one cycle of operation of the polishing tool.

2. The controller according to claim 1, wherein the controller changes the operating command in small increments in the course of at least one cycle of operation of the polishing tool.

3. The controller according to claim 1, wherein the controller changes the operating command periodically or at random.

4. The controller according to claim 1, wherein a surface of the electrode is formed with ridges or grooves extending radially from a center of the electrode.

5. The controller according to claim 1, wherein a surface of the electrode is formed with ridges or grooves extending curved radially from a center of the electrode.

6. The controller according to claim 1, wherein the operating command includes one of a current, speed, and position.

7. An electrode polishing method controlling at least one of a first drive source for applying pressure to an electrode, a second drive source for driving a polishing tool for polishing the electrode, and a third drive source for changing at least one of a position and orientation of one of the electrode and the polishing tool with respect to the other so as to polish the electrode, wherein the electrode polishing method comprises a step of making an operating command of the first drive source or at least one of the third drive source and the second drive source to be peak-shaped and valley-shaped in the course of at least one cycle of operation of the polishing tool.

8. An electrode polishing system comprising:
a resistance welding machine having a first drive source for applying pressure to an electrode;
an electrode polishing apparatus having a second drive source for driving a polishing tool for polishing the electrode;
a third drive source for changing at least one of a position and orientation of one of the electrode and the polishing tool with respect to the other; and
a controller for controlling at least one of the first drive source, the second drive source, and the third drive source,
wherein the controller changes an operating command of the first drive source or at least one of the third drive source and the second drive source to be peak-shaped and valley-shaped in the course of at least one cycle of operation of the polishing tool.
